(19) United States
(12) Patent Application Publication
(10) Pub. No.: US 2003/0033524 A1
(43) Pub. Date: Feb. 13, 2003

(54) Client aware authentication in a wireless portal system

(76) Inventors: Luu Tran, Santa Clara, CA (US); Bina Keshava, Union City, CA (US); William York, Brighton, CO (US)

Correspondence Address: WAGNER, MURABITO & HAO LLP, Third Floor, Two North Market Street, San Jose, CA, 95113, US

(21) Appl. No.: 09/929,476

(22) Filed: Aug. 13, 2001

(51) Int. Cl. H04L 9/00

(52) U.S. Cl. 713/168; 380/247

(57) ABSTRACT

A wireless portal system having a wireless server with a client aware authentication system. The client aware authentication system includes logic for automatically identifying client wireless devices connecting to the wireless server by using particular characteristics of the client in granting service connection requests from the client to the server. Depending on the client type, one or more, client-specific authentication modules are selected for the Client. In this way, the invention provides dynamic selection of authentication modules based on the Client type of an identified client. In one embodiment of the invention, the client aware authentication system includes extensible modular authentication parameters that allows the client to add-on client information characteristics which are not already pre-stored in the wireless server.

### CROSS REFERENCE TO RELATED APPLICATION

This patent application is related to co-pending patent application Ser. No. ______, filed on ______, by Luu Tran et al., entitled “Extensible Client ware Detection in a Wireless Portal System,” attorney docket number SUN-P6087, which is hereby incorporated herein by reference in its entirety.

### FIELD OF THE INVENTION

The present claimed invention relates generally to the field of wireless communication systems. More particularly, the present claimed invention relates to client aware authentication in a client independent wireless environment.

### BACKGROUND ART

The Internet has become the dominant vehicle for data communications. And with the growth of Internet usage has come a corresponding growth in the usage of Internet devices, wireless devices and services.

The growing base of Internet users has become accustomed to readily accessing Internet-based services such e-mail, calendar or content at any time from any location. These services, however, have traditionally been accessible primarily through stationary PCs. However, demand is now building for easy access to these and other communication services for mobile devices.

As the demand for mobile and wireless devices increases, enterprises must rollout new communication capabilities beyond the reach of traditional wired devices, by extending the enterprise with extra-net applications, etc., to effectively and efficiently connect mobile employees with their home base. As the number of digital subscribers grows, traditional wireless providers must find applications suitable to the needs of these new mobile users.

However, service providers are not the only ones seeking applications to meet the growing service needs of wireless users. Traditional portal developers are also extending their traditional PC browser desktop services to these new wireless markets.

With the growth of the wireless market comes a corresponding growth in wireless business opportunities which in today's ever-growing markets means, there is a plethora of services available to customers of the people that use these services. Many wireless service providers are now looking to add to basic core services by extending services such as e-mail, short messaging service notification, and other links to IP-based applications to drive additional business and revenues.

As the wireless market grows and Internet access becomes more mainstream and begins to move to new devices, wireless service providers are looking to develop highly leveraged Internet Protocol based applications on top of existing network infrastructure. To meet the growing demand for wireless client devices, enterprises need to provide access to any type of service from any type of device from anywhere and to provide content suitable for these devices without incurring substantial cost overhead.

The growth in wireless devices also means that traditional computer users who used to be tied to their desktop computers may now be mobile and would require remote access to network applications and services such as email. The mobility of wireless users presents a host of challenges to service providers who may have to provide traditional service to these new wireless devices. One such service is provided by Sun Microsystems, Inc., through its iPlanet™ platform to allow service providers to grow their services from basic traditional services such as voice to leading edge wireless applications with carrier-grade reliability and performance.

In addition to the traditional network applications that these new wireless users seek, the growth of the Internet and the introduction of new Internet enabled wireless devices have led to the explosive use of community-based web sites or portals. The growth in portals has created a need for wireless environments to provide portal support to handle the collection of data related to different topics such as news, stock quotes, applications and services required by wireless device users.

FIG. 1 depicts a prior art wireless client dependent based environment solution to handle similarly configured wireless client running similar applications or portals. The environment depicted in FIG. 1 includes wireless devices such as a WAP phone 101, a wireless PC 102, a refrigerator 103, etc. In general, the wireless environment depicted in FIG. 1 is categorized into the network (Internet 104), Clients (e.g. mobile phone 101, PCs 102 and household appliances 103) and resources (e.g., web-sites 105, portals 106 and other applications 107).

For most of the wireless clients connected to the Internet 104, portals 106 offer the client the starting point of experiencing the Internet 104. Portals 106 are typically community based web-sites that securely hold a collection of data related to different topics, including such applications as news, stock quotes, etc. For example, a wireless client connecting to the Internet will first login to a web portal site (e.g., yahoo) and from there browse through various sites to search for a host of different services.

The portals typically reside in a portal server which bundles an aggregation of services provided by an Internet service provider and provides these services to wireless clients. A wireless portal server such as that developed by Sun Microsystems, Inc. provides such portal access to wireless application resources residing on resource servers A 108, B 109 and C 110.

The prior art wireless server depicted in FIG. 1 primarily supports the two major types of browsers known by most Internet users. These include the Microsoft Internet Browser and the Netscape Communicator Browser. These browsers are both Hyper Text Markup Language (HTML) based and suitable for some wireless devices, especially devices with large display screens. However, as wireless display screens get smaller in size, traditional HTML browsers are no longer suitable for transmitting content to these wireless devices.

To ensure suitable content delivery, wireless device and wireless software providers have developed a myriad of micro-browsers which appropriately adapt to these wireless devices with different display screen requirements in order to take advantage of the numerous content on the Internet. The availability of these new micro-browsers means that service providers do not have to create different sets of content for different wireless devices even if the devices are dissimilar.

Authentication in the prior art system shown in FIG. 1 is performed on a per-platform basis. This requires all users to be authenticated using the same type of authenticating characteristics. The only way to have user-specific authentication is to send a menu that allows the users to choose an authentication option. This is not acceptable or easily extensible when hosting multiple networks or when supporting different types of users.

Authentication in the prior art was therefore domain-based and role-based, but not client-based. A user's domain is determined upon the initial contact with the gateway. The gateway then passes the domain to an authentication server to authenticate the user. Clients requesting services to the wireless environment are therefore authenticated based on the same type of credential which is based on information such as the user's identification (user-id) and the user's password. These credentials are useful if the client is a wireless PC with a large enough keyboard form factor to allow the user to key in the required credential information.

However, when it comes to wireless phones and other wireless hand-held clients, the limited keyboard form factor imposes limitations on the user's ability to enter the user credential each time the user logs into the wireless environment. The server in FIG. 1 also assumes any authentication request to emanate from a Hyper Text Markup Language (HTML) browser and consequently lacks virtually any client type identification attributes.

A further disadvantage of the credential only based authentication systems of the prior art is that they offer limited protection and security because user credentials are very easy to “hack”. This enables unauthorized clients to log into the wireless server from anywhere and assume the identity of legitimate users. The prior art authentication systems did not provide wireless service providers or users the flexibility to extend authentication characteristic of clients connected to the wireless network. This makes network security systems vulnerable to easy access.

### SUMMARY OF INVENTION

Accordingly, to take advantage of the myriad of applications and the numerous wireless clients being develop, a wireless server with extensibility capabilities to allow wireless clients to be dynamically configured and authenticated by the wireless server is needed. A need also exists for “out-of the-box” wireless client aware system solutions to allow technically inept end-users to connect to the wireless environment without unduly tasking the end-user's technical abilities. A need further exists for improved and less costly device-independent authentication system which improves efficiency and authentication of various wireless clients without losing the embedded features designed for these devices.

Embodiments of the present invention are directed to a system and a method for a wireless client aware authentication scheme in a wireless network environment. In general, embodiments of the present invention vary the degree of authentication modules required for authentication based on identified client detection information. In other words, the invention provides client-type specific authentication procedures in a wireless networked environment.

The present invention is capable of handling both voice and data transmission over an Internet protocol wireless system. The present invention further provides a system and method of providing varying degrees of authentication of a wireless client connecting to the wireless environment. The invention is suitably adapted to function in a wireless portal environment.

Embodiments of the invention include a pluggable authentication service module which verifies the identity of a user. The authentication service further creates and validates a portal session while redirecting a user's wireless client device to an appropriate portal application.

In one embodiment of the present invention, the authentication service delegates user identification and verification to various extensible authentication modules via authentication module APIs. The extensible authentication modules provide the wireless service provider the flexibility to be able to extend the authentication characteristics of the wireless client based on the client type.

Consequently, the authentication scheme of the present invention utilizes client-type information specific to a class of wireless device to provide a custom authentication procedure for the client. Additionally, the present authentication scheme uses client credentials to complement the client-type information to authenticate and authorize services to the client.

In another embodiment of the present invention, the authentication service generates Hyper Text Transport Protocol (HTTP) headers and the initial menu of the authenticators and error messages on various login failures for a client attempting to access the wireless server.

In yet another embodiment of the present invention, client-type characteristics, which typically includes a logical group of clients uniquely identified by an extensible list of properties, are dynamically provided by the authentication modules and selectively used in authenticating client requests. The present invention utilizes either one or more of the client characteristics in authenticating the wireless client in a wireless network environment.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

Prior Art FIG. 1 is a block diagram of a conventional device dependent wireless system;

FIG. 2 is a block diagram of an implementation of a device independent wireless system of an embodiment of the present invention;

FIG. 3 is a block diagram of an exemplary internal architecture of the wireless server of FIG. 2; and

FIG. 4 is a block diagram of an embodiment of an internal architecture of a client aware authentication process of an embodiment of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

The invention is directed to a system, an architecture, subsystem and method to manage a wireless client's authentication in a client independent wireless environment in a way superior to the prior art. In accordance with an aspect of the invention, a wireless server provides wireless client authentication which enables client characteristics of non predefined devices to be identified by the wireless server.

In the following detailed description of the present invention, a system and method for a wireless Internet protocol based communication system is described. Numerous specific details are not set forth in order to provide a thorough understanding of the present invention. However, it will be recognized by one skilled in the art that the present invention may be practiced without these specific details or with equivalents thereof.

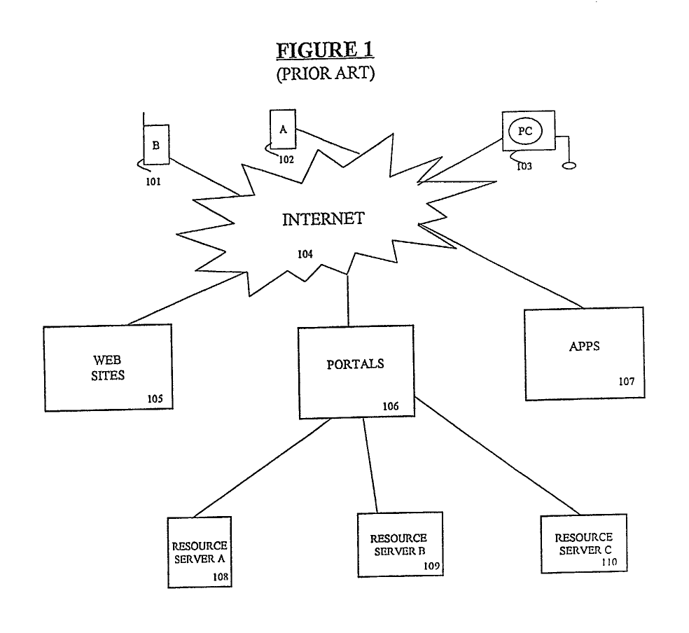

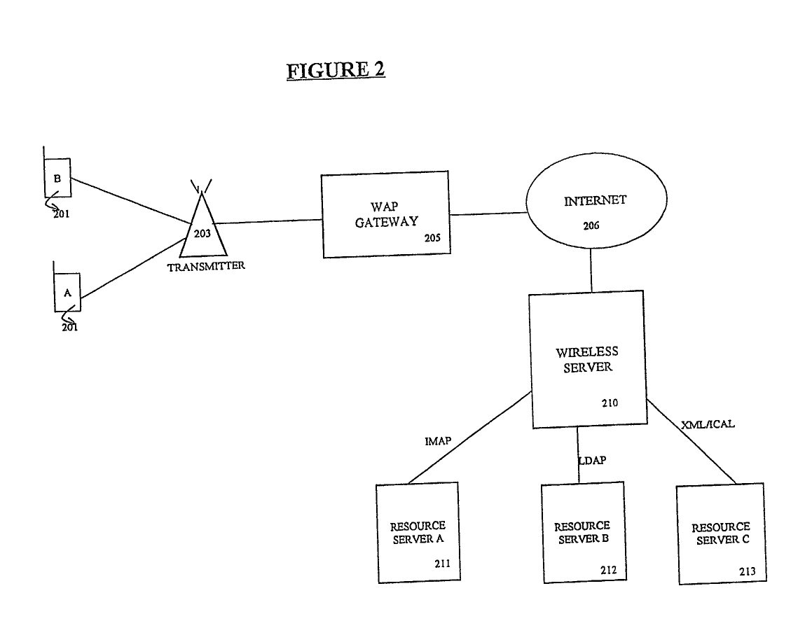

Generally, an aspect of the invention encompasses providing an integrated wireless Internet server which provides a wide range of voice, data, video and other services to wireless clients which may connect to the wireless environment to be serviced alongside predefined wireless clients. The invention can be more fully described with reference to FIGS. 2 through 4.

FIG. 2 depicts a wireless device independent based environment of the present invention. The wireless environment depicted in FIG. 2 comprises a wireless application protocol (WAP) based phone 201, a WAP transmission infrastructure 203, a WAP gateway 205, the Internet 206 and a wireless server 210. In a Global Switching Mobile network for instance, when the phone transmission is received by the mobile switching center, it realizes it is packet data and sends it to the proper channel to be processed. The WAP gateway 205 typically resides on the Local area network (LAN) within a telecom carriers premises. It is not generally a part of the wireless server. The WAP gateway 205 is responsible for connecting the Wireless Markup Language/Hyper Text Transport Protocol content and protocol into a bundled compressed, encoded, encrypted version of WML over WAP.

Conversely, the WAP gateway 205 also performs the translation of WAP commands into HTTP requests which can be sent over the public Internet. The WAP gateway 205 can also store user's bookmarks, two of which could point to the wireless server's messaging and other resource services. The wireless server 210 communicates Wireless Markup Language (WML) over HTTP on the front end and communicates in native protocol of the target server on the back-end.

The wireless server 210 communicates to these back-end resource servers using the backend server's native protocol. For example, the wireless server 210 may communicate to resource server A which may be a messaging server using IMAP. Lightweight Directory Access Protocol (LDAP) is used for all communications to and from the resource server B. And an Extensible Markup Language (XML) protocol may be used to communicate with resource server C.

Although the wireless server 210 depicted in FIG. 2 is capable of communicating in these native protocol shown in FIG. 2, the wireless server protocol's handling capability can be extended to support other protocols. The wireless server implements the WML interface and generates the corresponding WML content based on what it receives from the back-end server. The wireless environment depicted in FIG. 2 typically supports a wireless device of dissimilar configuration and is thus device independent.

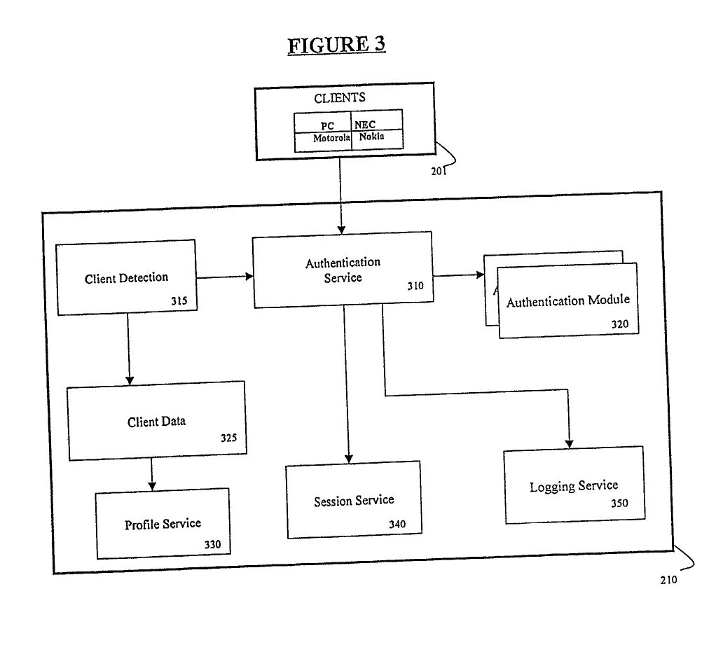

FIG. 3 is a block diagram illustration of one embodiment of the wireless server 210 of the present invention. Wireless Server 210 (WS) comprises, Authentication logic 310, Authentication Modules 320, Profile Service (PS) module 330, Session Service (SS) module 340, Client Detection module 350 and Client Data module 360. WS 210 may include other modules which have not been disclosed here in order not to confuse the teachings of the present invention.

The wireless server 210 shown in FIG. 3 is a flexible, scalable, extensible and capable of supporting a rich evolving range of networks such as Global System for Mobile communication (GSM) Networks, Code Division Multiple Access (CDMA) Networks, Time Division Multiple Access (TDMA) Networks, Third Generation (3G) Networks and others.

The architecture of the server is also capable of handling a variety of wireless environments and markup languages such as the wireless markup language (WML), the handheld device markup language (HDML) and the hypertext markup language (HTML). The server 210 is capable of providing support for multiple devices and is easily adaptable and extensible to additional devices and markup languages.

AS 310 is the first part of the wireless server 210 that comes into contact with the end-user. AS 310 receives client service requests to WS 210 via a client authentication software APIs and importantly authenticates such requests. AS 310 verifies the identity of a user, creates and validates a portal session and redirects the user's client to an appropriate wireless application. As used throughout this application, a “client” refers to independent wireless devices which may connect to the wireless server. In accordance with embodiments of the present invention, AS 310 performs client or device specific authentication as defined with device specific parameters.

Depending upon the Uniform Resource Locator (URL) given, the end-user will either see a menu displaying all the registered authentication modules on the end-user's wireless client available for use or they are automatically linked to a specific login module pre-designated for a particular class of client type. AS 310 uses client-type information received from Client detection module 350 in determining the appropriate service module to invoke in response to the client request. The Function of Client Detection Module 350 is described in the co-pending U.S. patent application entitled “CLIENT AWARE DETECTION IN A WIRELESS PORTAL SYSTEM”, filed ______, assigned to the assignee of the present invention and hereby incorporated herein by reference.

Consequently, AS 310 is not directly tied to any particular markup language. The authentication service 310 saves the client-type information in Session Service 340 and determines the next appropriate module to invoke via an authentication module selection chain.

AM 320 is a group of independently pluggable authentication modules which receives Client-Type information passed by AS 310 to set the appropriate client-type headers to generate appropriate service content in response to a client request. In the present invention, AM 320 is extensible to enable the authentication service 310 to use a host of different client characteristics to authenticate clients accessing the wireless network. Therefore, by using AM 320, the invention provides dynamic selection of authentication modules based on client aware detection.

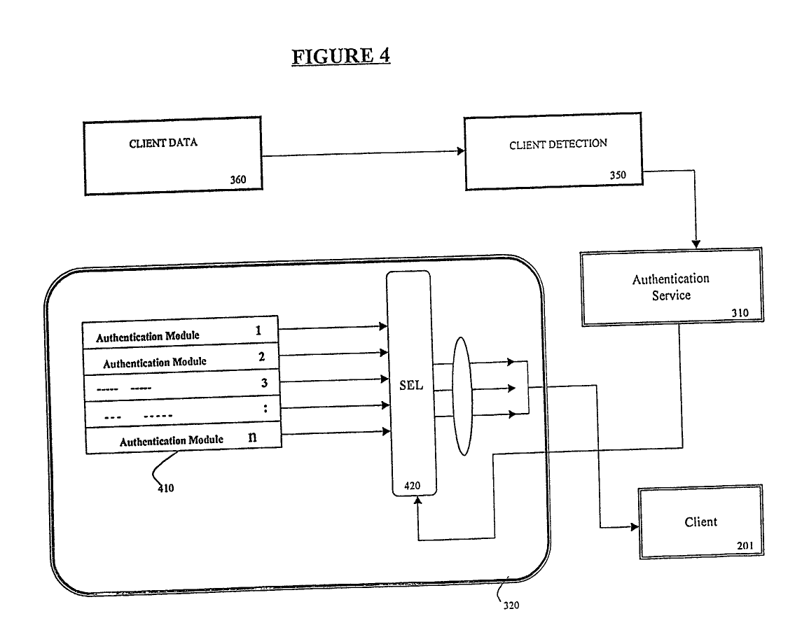

FIG. 4 is a block diagram illustration of one embodiment of the Authentication Modules 320 of the authentication system of the present invention. The Authentication Modules (AM) 320 include independently pluggable modules 410 and module selector 420.

The Client Data module 360 provides client awareness data for authenticating clients that attempt to access the wireless server 210. AM 320 includes individual authenticating modules which represent different verification attributes that may be used to uniquely authenticate clients.

These individual authentication modules include predefined client characteristics which may be equipment manufacturer specific or service provider specific. Some of the client characteristics which may be used to authenticate a client includes client's browser type, client's browser version, type of wireless service the client subscribes from a service provider and the time of day such services are subscribed, the user's user-id and password. The authentication modules may also include LDAP authentication, secure ID, radius authentication, UNIX authentication, membership authentication, etc.

When the authenticating service 310 receives client initiated authentication requests, the authenticating services 310 invokes the appropriate authentication module from Modules 410 to load files based on the client accessing the server 210. In the prior art, most authentication requests to the wireless server 210 were assumed to emanate from HTML based devices. Prior art clients were therefore authenticated based on only the user name and password. On the other hand, the present authenticating procedure utilizes client characteristics other than the user name and password to verify authentication requests.

AM 320 is modular and extensible to enable the dynamic addition of run-time client-type information which is gathered when a client attempts to connect to the server 210. By being extensible, the authentication module 410 allows service providers to add their own unique authentication parameters on top of the predefined authentication parameters in the server 210 to enable the service provider to distinguish and identify their customers from others who use the server 210.

Having an extensible modular authentication scheme also enables the wireless service provider to implement simple code additions to the authentication service 310 rather than a more expensive upgrade of the entire wireless server each time the service provider wants to change its predefined authentication parameters

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A client aware authentication system in a wireless network, comprising:
a wireless server; and
a plurality of classes of wireless clients, each of said classes of wireless clients having unique authentication parameters.

2. The client aware authentication system of claim 1, comprises a plurality of authentication modules coupled to an authentication service and wherein said authentication service is for dynamically selecting an authentication service module based on the class of a client.

3. The client aware authentication system of claim 2, wherein said authentication service receives and parses client type information of the wireless clients to determine the authentication characteristics of the wireless clients.

4. The client aware authentication system of claim 3, wherein the plurality of authentication modules comprises a set of predefined authentication parameters used by the wireless server to authenticate the wireless clients with known authentication characteristics accessing the wireless server.

5. The client aware authentication system of claim 4, wherein the authentication module further comprises authentication parameters dynamically extracted from client type information of the wireless clients accessing the wireless server.

6. The client aware authentication system of claim 5, wherein the authentication module selectively provides client specific authentication information to authenticate the wireless clients accessing the wireless server.

7. A wireless server system, comprising:
a plurality of authentication modules each providing respective authentication parameters pertinent to a type of client; and
an authentication service, in response to receiving a particular client type associated with a particular wireless device, for dynamically selecting an authentication module of said plurality of authentication modules based on said particular client type,
wherein said authentication service is also for applying a selected authentication module to said particular wireless device for the authentication thereof.

8. A wireless server system of claim 7, further comprising an automatic client detection service for automatically detecting said particular client type in response to service requests that originate from said particular wireless device.

9. The wireless server system of claim 8, wherein said service requests comprise header information which is used to detect said particular client type.

10. The wireless server system of claim 9, wherein said header information comprises hyper text transport protocol request headers.

11. The wireless server system of claim 10, wherein said header information comprises programmable user specific headers.

12. The wireless server system of claim 11, wherein said header information comprises client equipment manufacturer specified headers.

13. The wireless server system of claim 8, wherein said plurality of authentication modules comprise:
a user identification module;
a password module;
a membership module;
a securID module;
a safeword modules;
a S/key module;
a Microsoft Windows/NT module; and
a nopassword module.

14. The wireless server system of claim 13, wherein said plurality of authentication modules further comprise:
an LDAP authentication module;
a radius authentication module; and
a UNIX authentication module.

15. A wireless server, comprising:
a client aware authentication service logic;
a plurality of client aware authentication modules;
a client data storage module for storing client type information; and
a session service module for storing transient session information for a client requesting authentication to said wireless server.

16. The wireless server of claim 15, wherein the authentication service logic authenticates clients attempting to access the wireless server.

17. The wireless server system of claim 16, wherein the authentication service logic retrieves client type information from said client data storage and stores the client type value in the session service logic to enable the client to be authenticated by the wireless server.

18. The wireless server of claim 17, wherein the authentication modules comprise a set of predefined authentication parameters for authenticating known classes of wireless clients that access the wireless server.

19. The wireless server of claim 18, wherein the authentication modules comprise a set of dynamically extracted authentication parameters from service request headers from the wireless clients.

20. The wireless server of claim 19, wherein the authentication modules comprise selection logic to selectively choose authentication parameters in response to a client service request.

21. The wireless server of claim 20, wherein said client service request comprises hyper text transport protocol request headers.

22. The wireless server of claim 21, wherein said client service request comprises client equipment manufacturer specific headers.

23. The wireless server of claim 22, wherein the client service request includes programmable user specified headers.

24. A client aware authentication module, comprising
a plurality of client aware characteristics modules; and
client aware authentication selection logic.

25. The client aware authentication module of claim 24, wherein said plurality of client aware characteristics modules comprise predefined set of client characteristics for authenticating known clients accessing the client aware authentication modules.

26. The client aware authentication module of claim 25, wherein said plurality of client aware characteristics modules comprise client characteristics dynamically extracted from the clients run-time environment.
